(19) United States
(12) Patent Application Publication
(10) Pub. No.: US 2007/0052252 A1
(43) Pub. Date: Mar. 8, 2007

(54) Release hook

(76) Inventors: Gerd Rohardt, Hipstedt (DE); Ekkehard Schuett, Bremerhaven (DE)

Correspondence Address: Law Offices of Karl Hormann, P.O. Box 381516, Cambridge, MA, 02238-1516, US

(21) Appl. No.: 11/510,893

(22) Filed: Aug. 27, 2006

(30) Foreign Application Priority Data
Sep. 2, 2005 (DE) DE 2809970 A1

(51) Int. Cl. B66C 1/34

(52) U.S. Cl. 294/82.3

(57) ABSTRACT

A release hook for selectively holding and releasing a load and provided with operating equipment in a plurality of modules disposed in a water-proof housing made of yielding material, the modules being, for the prevention of damage from shock, together or individually embedded in a casting compound in the housing. External shock absorbers on the housing are provided as further impact protection.

### BACKGROUND OF THE INVENTION

1. Field of the Invention

The invention relates to a release hook with operating means structured as a latch system releasable under a predetermined load by a battery-operated electric release drive, command execution circuitry and a remote control for the wireless release of the latch system as well as with a housing for the operating means.

2. The Prior Art

Such release hooks are used for positioning loads at locations which are either not accessible to humans at all or with difficulty only, where they position, discharge or generally release their load by remote control. They consist of a rigid part and a load-receiving part moveable relative thereto which is arrested by a latch system. For releasing the load, the latch system and, hence, the moveable part of the release hook, are release by remote control. The releasable part can then, under the effect of the load force, move to its open position and discharge the load.

DE 694 21 239 T2 discloses a device for lifting heavy loads and provided with a latch system which can be released by remote control. A release signal causes an electromagnet to release a latch which after release of the device discharges the carrier ropes when the load has been positioned. The carrier ropes structured as open loops are attached to the fixed part of the device by a spliced eyelet at one end mounted in a shackle, pulled through eyelets on the load, and by a retaining bolt which is affixed to the moveable part of the device seated in a further spliced eyelet at the free end of the rope, and which in its latched state is guided through, and protruding from, a center path of the rigid part of the device. When the latch is actuated following the deposit of the load, the moveable part of the device can, while the device is being raised, slide downwardly out of the fixed part of the device far enough for the retaining bolt in the center path to recede and thus release spliced eyelets at the free ends of the carrier ropes. Further raising of the device causes the free ends of the carrier ropes to slide out of the eyelets of the load. The retaining device can be recovered completely with the carrier ropes; only the eyelets remain on the load. The type of current supply of the receiving unit has not been described in any detail. The device is relatively large, unwieldy and designed for larger loads. The release can take place only in the unloaded state and is thus unsuitable for depositing loads on the surface of water.

DE 28 09 970 A1 discloses a fixedly mounted release hook for use in harbors and docks which is provided with a latch system using toggle levers which in a position beyond dead center is self-retainingly closed under the force of the load. When required the toggle lever is returned beyond dead center by a pulling line and the latch system frees the moveable part of the release hook so that the load is released. There is no need for executing a special command since under the force of the load the moveable part of the release hook moves into a position at which the load is completely released from the hook. The device cannot on its own return to its initial position; but needs manual service for renewed latching. This structure is an example of the most common form of load holding device as a manually operated apparatus; but in its presented form it is not suitable for depositing loads on water surfaces. An improved load holding device structured as a release hook has been presented by DE 1,902,416. Its latching system is constituted by a locking pawl which can be actuated hydraulically. As a result of the holding force of the hydraulic cylinder there is no need here for a low-force retention as in the case of toggle levers. Rather, the moveable part of the release hook can be directly maintained in its closed position by the pawl. For unlatching, the pawl is simply withdrawn by the hydraulic cylinder, and the release hook is thus released. Here, too, no command need be executed since the release hook can automatically move sufficiently for the complete release of a load. This device can also not on its own return to its initial position. Neither the type of oil and current supply nor the release device has been disclosed in any detail.

U.S. Pat. No. 5,513,886 representing the closest prior art upon which the invention is based, describes a two-component device called “pelican hook”, one part of which is stationary and the part of which can be pivoted against the stationary part such that a load caught between the two parts is released. The release takes place by a motorized 360° rotation of a cam which partially circumscribes a pin-like foot of the moveable part of the device. During the first 180° of rotation then cam releases the latched foot pin and during the following 180° it pushes the foot pin outwardly such that by the pivoting of the moveable part about its central axis at its hook-shaped end opposite the foot pin the load between the two parts of the device is released. The command execution circuitry monitors the 360° rotation via a termination switch, and receiving a new load is initiated by reversing the rotation of the motor and of the cam. The device can be controlled for underwater applications by a wireless control and, if necessary, by an acoustic transponder. Current to the motor and to the control signal receiver may be supplied by a battery. The device is unwieldy and its manufacture is complex. It is designed for smaller and medium loads, and it can be released under a load. The device here described is intended for stationary operations. Possible applications are, for instance, the placing or dropping of loads in inaccessible areas from a helicopter, on the open sea or on the sea bed from a crane onboard ship as well as the release of a underwater device from an anchor. In the simplest case, a remote actuator would be a pulling line for overcoming a resistance in the latch system. Motorized or electromagnetic releases by wire or by remote control are also known. When depositing of loads in the sea from slow-moving ships the release hook may be pulled from the stern prior to the release of the partially submerged load. Following release, the lowering line and the release hook swing back on the arm of the crane and may thus be damaged on the hull of the ship, especially in case of integrated sensitive components such as motor and magnetic drives and wireless remote controls as well as battery sets.

### OBJECTS OF THE INVENTION

It is a primary object of the invention so to improve a release hook of the kind referred to that it may be manufactured to be robust.

Another object of the invention is to provide a release hook the operation of which is simple.

Yet another object of the invention is to provide a release hook suitable for operation on board ships on the surface of water.

It is also an object of the invention to provide a release hook which is well protected from damage as a result of impact forces.

Other objects and advantages will in part be obvious and will in part appear hereafter.

### BRIEF SUMMARY OF THE INVENTION

In the accomplishment of these and other objects the invention provides for a release hook provided with a housing for its operating equipment which is water proof but not pressure resistant and which at its outer contour is provided with shock absorbers and for the operating equipment in the housing to be embedded in a casting compound.

The release hook in accordance with the invention consists of an uninterrupted load receiving shaft provided at its upper end with a grommet or the like for connection with the hook of a crane. The latching system releasable by remote control and to which a load would be attached is provided at the lower end. Laterally of the shaft there is provided a housing for operating equipment. Within it, there is provided an electric release drive, e.g. a small highspeed motor with a space-saving transmission or a low-speed motor without a transmission, or a magnetic drive. Any one of the release drives acts upon the latch system by a magnetic coupling. Furthermore, the wireless remote control for initiating the release, terminal switches of the command execution circuitry connected with the mechanical coupling and the battery for feeding the release drive and wireless control are arranged within the housing. A receiving antenna for the remote control is provided at the exterior of the housing. While for depositing loads on a water surface the housing will be exposed to the water but it will not be subjected to pressure. For reducing the weight of the release hook it is, therefore, possible to fabricate the housing from a light and thin material and to seal it against water penetration at its seams and exit flanges for the mechanical coupling. Advantageously, the housing may be made of a thin corrosion-resistant sheet of stainless steel or of a suitable plastic material. Every reduction of weight at the components results in an improvement in the handling of the apparatus on board and reduces costs.

The ship may be traveling at low speed when a load is being unloaded. As regards the load this is uncritical but in many cases it is necessary. Where the load is a multiple-component device connected by a rope, e.g. a measuring instrument at a surface buoy for taking measurements at a predetermined depth, the measuring will submerge first followed by the buoy somewhat later, so that only than can the release hook be released. At this point in time the release hook on the hoisting line is no longer directly below the crane hook but has drifted off moire or less to the rear. After release of the release hook the load is finally freed, and the release hook on the hoisting line will swing back in the direction of the ship. It is possible, especially in cases in which unloading takes place from the stern of the ship, that it crashes against the hull of the ship and suffer considerable damage. Such damage would primarily be suffered by the sensitive drive means of motor, transmission, release mechanism, wireless remote control and battery which might become deformed or shifted and, hence, inoperative. But the light housing, too, may become deformed and thus may no longer be able to fulfill its task of sealing. To prevent damage as a result of crashes against the hull of the ship, the housing may be provided with shock absorbers. It is advantageous to structure the shock absorbers in the manner of elongated fenders and to distribute at least three of them over the circumference of the housing. Another advantageous manner is to structure the shock absorbers annularly and to provide at least two of them over the length of the housing. Such arrangements ensure that the housing does not directly contact the hull of a ship. In an advantageous embodiment the shock absorbers are light air-filled hollow bodies. In addition to sufficient shock absorption, such a measure ensures a light weight which, in turn, favorably affects the weight.

The arrangement of the operating equipment in the interior of the housing and the dampening of any shock notwithstanding, bending of the mechanisms or shifting and contact problems in the electronics may nevertheless occur as a result of engagements with the hull. For this reason the operating equipment is arrested in a casting compound. For purposes of carrying out maintenance of the motor, mechanisms or battery it is particularly advantageous to arrest the operating equipment in the casting compound in the housing as several divided functional groups. They may then be exchanged or removed and maintained individually. For the current supply in particular it is especially advantageous to provide the battery as a rechargeable battery arrested in the casting compound as separate component. In that case it would not be necessary to exchange batteries or each time to fabricate a new cast body. Instead the encased rechargeable battery could be removed and reinserted unchanged after recharging.

### DESCRIPTION OF THE SEVERAL DRAWINGS

The novel features which are deemed to be characteristic of the invention are set forth with particularity in the appended claims. The invention itself, however, in respect of its structure, construction, lay-out and design, as well as manufacturing techniques and technology, together with other objects and advantages thereof will be best understood from the following description of the preferred embodiments when read with reference to the appended drawings, in which:

FIG. 1 depicts an external view of a release hook in accordance with the invention;

FIG. 2 is a top elevational view a release hook with fender-like shock absorbers;

FIG. 3 is a planar view of a release hook with annular shock absorbers; and

FIG. 4 is a section through the housing.

### DETAILED DESCRIPTION OF PREFERRED EMBODIMENTS

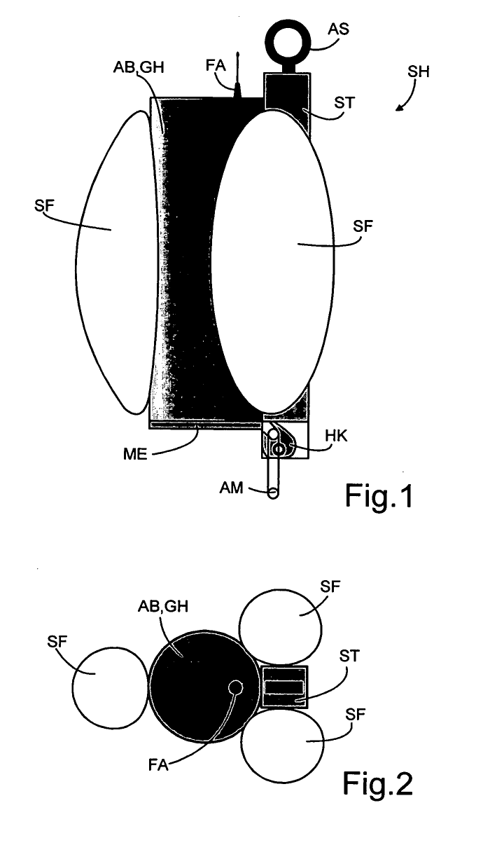

As used herein, the terms eyelet, grommet, eye bolt and the like are not intended to be used by their literal meaning but rather as a concept of fasteners suitable for a defined purpose. FIG. 1 is an overall view of a release hook SH in accordance with the invention. The load transmitting shaft ST is hung on a crane or similar hoisting structure (not shown) by means of an eyebolt AS. At the lower end, a load is received by a closed hook HK by way of a suspension means AM. The release drive AB is disposed laterally of the shaft ST. It contains such operating equipment as the motor MR, wireless remote control FF and battery BI, which have not been shown in the Figure. Only the wireless antenna FA is arranged at the upper side of the housing. The release drive AB consists of a housing GH and the mechanical coupling ME. The housing GH is water-proof, it is not pressure resistant and can easily be opened for purposes of maintenance. The mechanical coupling ME engages the hook HK. Fender-like shock absorbers SF formed as light air-filled hollow bodies are provided for protection against damage from crashes against the hull. The absorbers SF extend over the length of the release hook HK and at least three of them are distributed around the circumference of the circumference of the release hook HK.

FIG. 2 depicts the release hook SH in top elevation. Three fender-like shock absorbers SF are arranged around the combination of shaft ST and release drive AB such that when crashing against the hull at any position, the shock will in any case be absorbed by one or two of the fender-like shock absorbers SF rather than the shaft ST or the drive AB.

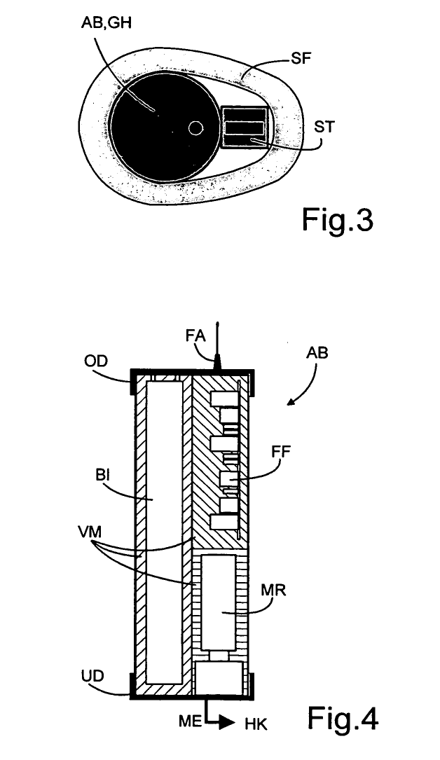

FIG. 3 is a top elevational view of a release hook SH provided with annular shock absorbers SF, being light and air-filled as well, at least two of which are distributed to extend over the length of the release hook SH.

FIG. 4 is a sectional view of the housing GH of the release drive AB. The operating equipment, i.e. motor MR, wireless remote control FF and battery BI are arrested as separate modules in a casting compound. The battery BI may for charging easily be removed through an upper water-proof lid OD. The electrically insulated wireless antenna FA is also located at this position. The mechanical coupling ME engages the hook HK through the water-proof lid UD.

What is claimed is:

1. A release hook, comprising:
a latching system including operating equipment, comprising:
an electric release drive;
means responsive to a signal for energizing the release drive;
means responsive to the release;
a housing made of water-proof material yielding under pressure; and
a casting compound within the housing for securing the operating equipment from external shock.

2. The release hook of claim 1, wherein the operating equipment further comprises an electrical battery for energizing the release drive and the release responsive means.

3. The release hook of claim 2, wherein the housing is made of one of thin corrosion-resistant stainless steel and plastic.

4. The release hook of claim 3, wherein the exterior of the housing is provided with a plurality of shock absorbers.

5. The release hook of claim 4, wherein the shock absorbers are of fender-like structure.

6. The release hook of claim 5, wherein the shock absorbers are arranged around the circumference of the housing.

7. The release hook of claim 6, wherein the shock absorbers extend over the length of the housing.

8. The release hook of claim 4, wherein the shock absorbers are structures as light air-filled bodies.

9. The release hook of claim 2, wherein the components of the operating equipment are embedded in the casting compound as separate functional units.

10. The release hook of claim 2, wherein the battery is a rechargeable battery embedded in the casting compound as a separate component.

11. The release hook of claim 2, further comprising:
an elongated shaft disposed laterally of the housing;
means at one end of the shaft for suspending the shaft from an extraneous device; and
means at the other end of the shaft for supporting the release hook.
